(19) United States
(12) Patent Application Publication
(10) Pub. No.: US 2025/0115159 A1
(43) Pub. Date: Apr. 10, 2025

(54) POWER CONTOLLING METHOD FOR AN ELECTRIC VEHICLE AND AN ELECTRIC VEHICLE CONTROLLED BY THE SAME

(71) Applicants: HYUNDAI MOTOR COMPANY, Seoul (KR); KIA CORPORATION, Seoul (KR)

(72) Inventor: Hyung Gyu Ra, Hwaseong-si (KR)

(73) Assignees: HYUNDAI MOTOR COMPANY, Seoul (KR); KIA CORPORATION, Seoul (KR)

(21) Appl. No.: 18/903,088

(22) Filed: Oct. 1, 2024

(30) Foreign Application Priority Data
Oct. 6, 2023 (KR) 10-2023-0133397

(51) Int. Cl. B60L 58/12

(52) U.S. Cl. CPC B60L 58/12; B60L 2250/24; B60L 2250/26

(57) ABSTRACT

A method for controlling power of an electric vehicle is provided. The electric vehicle includes a start button, a high voltage battery, a driving essential device configured to receive power from the high voltage battery, a convenience device configured to receive power from the high voltage battery, and a controller configured to convert a power mode to one of a first power mode or a second power mode. The method includes converting, by the controller, the power mode to the first power mode in response that the start button is operated one time in the off mode; converting the power mode to the second power mode in response that the start button is operated and a brake is operated in the off mode or the first power mode; and converting the power mode to the off mode in response that a first set time elapses in the first power mode.

### CROSS-REFERENCE TO RELATED APPLICATIONS

The present application claims the benefit of and priority to Korean Patent Application No. 10-2023-0133397, filed on Oct. 6, 2023, the entire contents of which are incorporated herein for all purposes by this reference.

### TECHNICAL FIELD

The present disclosure relates to a power controlling method for an electric vehicle and relates to an electric vehicle controlled by the method.

### BACKGROUND

In a conventional electric vehicle, the power mode consisted of four mode systems: OFF mode, adaptive cruise control mode (ACC mode), ignition control mode (IGN mode), and READY mode.

Here, ACC mode is a mode in which power is applied to convenience devices in a vehicle, IGN mode is a mode in which power is applied to all devices in the vehicle, and READY mode is a mode in which the vehicle can be driven at any time by releasing the brake pedal and pressing the accelerator pedal.

If a start button is pushed without brake operation, the power mode is switched from OFF mode to ACC mode, and if the start button is pushed twice without brake operation in OFF mode, the power mode is switched to IGN mode. If the brake pedal is pressed and the start button is pushed in a state that a shift lever is at the parking position (hereinafter, referred to as P range) or the neutral position (hereinafter, referred to as N range), the power mode is switched to READY mode.

### SUMMARY

The present disclosure provides a method for simplifying the power mode in an electric vehicle and preventing battery overconsumption in the simplified power mode system.

The present disclosure provides a control method for effectively converting power mode by adding utility mode in an electric vehicle.

The present disclosure provides a conversion method to a power off mode during driving or in a state that a shift level is not in P range.

According to an embodiment of the present disclosure, a method of controlling power of an electric vehicle is provided. The electric vehicle includes a start button, a high voltage battery, at least one driving essential device configured to be supplied power from the high voltage battery, at least one convenience device configured to be supplied power from the high voltage battery, and a controller configured to convert a power mode to one of an off mode, a first power mode, or a second power mode. The method includes converting, by the controller, the power mode to the first power mode in response to a determination that the start button is operated one time in the off mode. The method further includes converting the power mode to the second power mode in response to a determination that the start button is operated and a brake is operated in the off mode or the first power mode. The method further includes converting the power mode to the off mode in response to a determination that a first set time elapses in the first power mode. The first power mode is a mode in which the power is applied to the at least one convenience device, and the second power mode is a mode in which the power is applied to the at least one driving essential device.

In at least one embodiment of the present disclosure, the method may further include converting, by the controller, the power mode to the off mode in response to a determination that the start button is operated before the first set time elapses in the first power mode.

In at least one embodiment of the present disclosure, the method may further include converting, by the controller, the power mode from the second power mode to the first power mode in response to a determination that the start button is operated in a state that a shift lever is not in P range or during driving.

In at least one embodiment of the present disclosure, the method may further include converting, by the controller, the power mode to a third power mode in response to a determination that the third power mode is selected through a user settings menu of a user interface in the first power mode or the second power mode. The third power mode is a mode in which the power is applied to the at least one convenience device.

In at least one embodiment of the present disclosure, the method may further include outputting, by the controller, a pop-up window requesting a user selection for conversion to the third power mode through the user interface before the first set time elapses.

In at least one embodiment of the present disclosure, the method may further include automatically converting the power mode to the third power mode in response to a determination that a state of charge (SOC) of the high voltage battery is equal to or greater than a first set SOC.

In at least one embodiment of the present disclosure, the method may further include outputting, by the controller, a warning message through the user interface in response to a determination that the SOC of the high voltage battery reaches a second set SOC in the third power mode.

In at least one embodiment of the present disclosure, the method may further include converting, by the controller, the power mode to the second power mode in response to a determination that the brake and the start button are operated in the third power mode.

In at least one embodiment of the present disclosure, converting the third power mode to the second power mode is performed in response to recognition of a digital key within the electric vehicle when a second set time has elapsed. Converting is performed without the recognition of the digital key within the electric vehicle when the second set time has not yet elapsed.

In at least one embodiment of the present disclosure, the second set time is counted from a start of the first power mode in response to a determination that the first power mode is converted to the third power mode. The second set time is counted from a start of the third power mode in response to a determination that the second power mode is converted to the third power mode.

In at least one embodiment of the present disclosure, the method may further include converting, by the controller, the power mode to the first power mode and converting a shift lever to P range. The method may further include converting the first power mode to the off mode, in response to a determination that the start button is operated during driving in the second power mode.

In at least one embodiment of the present disclosure, converting the power mode to the second power mode includes converting the power mode to the second power mode in response to recognition of a digital key within the electric vehicle when a second set time has elapsed since a start of the first power mode. Converting the power mode to the second power mode further includes converting the power mode to the second power mode without the recognition of a digital key within the electric vehicle when the second set time has not yet elapsed.

In at least one embodiment of the present disclosure, the method may further include outputting, by the controller, a warning message, in at least one of a first case where conversion to the off mode is requested according to operation of the start button or a vehicle door is opened in a state where a shift lever is not in P range in the second power mode, a second case where conversion to the second power mode is requested by operation of the start button in a state where the shift lever is not in P range in the first power mode, and a third case where conversion to the second power mode is requested by operation of the brake and the start button in a state where the shift lever is not in P range.

According to an embodiment of the present disclosure, an electric vehicle includes a start button; a high voltage battery; at least one driving essential device configured to receive power from the high voltage battery, at least one convenience device configured to receive power from the high voltage battery; and a controller configured to convert a power mode to one of an off mode, a first power mode, or a second power mode. The first power mode is a mode in which the power is applied to the at least one convenience device, and the second power mode is a mode in which the power is applied to the at least one driving essential device. The controller is further configured to convert the power mode to the first power mode in response to a determination that the start button is operated one time in the off mode. The controller is further configured to convert the power mode to the second power mode in response to a determination that the start button is operated and a brake is operated in the off mode or the first power mode. The controller is further configured to convert the power mode to the off mode in response to a determination that a first set time elapses in the first power mode.

In at least one embodiment of the present disclosure, the controller is further configured to convert the power mode to the off mode in response to a determination that the start button is operated before the first set time elapses in the first power mode.

In at least one embodiment of the present disclosure, the controller is further configured to convert the power mode to the first power mode from the second power mode in response to a determination that the start button is operated in a state that a shift lever is not in P range or during driving.

In at least one embodiment of the present disclosure, wherein the controller is further configured to convert the power mode to a third power mode in response to a determination that the third power mode is selected through a user settings menu of a user interface in the first power mode or the second power mode. The third power mode is a mode in which the power is applied to the at least one convenience device.

In at least one embodiment of the present disclosure, the controller may output a pop-up window requesting a user selection for conversion to the third power mode through the user interface before the first set time elapses.

In at least one embodiment of the present disclosure, the controller is further configured to automatically convert the power mode to the third power mode in response to a determination that a state of charge (SOC) of the high voltage battery is equal to or greater than a first set SOC.

In at least one embodiment of the present disclosure, the controller is further configured to output a warning message through the user interface in response to a determination that the SOC of the high voltage battery reaches a second set SOC in the third power mode.

The methods and apparatuses of the present disclosure have other features and advantages, which should be apparent from or are set forth in more detail in the accompanying drawings, which are incorporated herein, and the following Detailed Description, which together serve to explain certain principles of the present disclosure.

According to an embodiment of the present disclosure, the power mode can be further simplified in electric vehicles and the battery overconsumption can be prevented in such a simplified power mode system.

In addition, it is possible to provide a control method for effectively converting power mode by adding utility mode in an electric vehicle.

In addition, it is possible to convert power mode to off mode during driving or in a state that a shift lever is not in P range.

### BRIEF DESCRIPTION OF THE DRAWINGS

FIG. 1 is a conceptual diagram showing the main configuration of an electric vehicle according to an embodiment of the present disclosure.

FIG. 2 shows a converted state of power modes according to an embodiment of the present disclosure.

FIG. 3 illustrates a pop-up window for utility mode conversion.

FIG. 4 shows a standby state control process in a first power mode according to an embodiment of the present disclosure.

FIG. 5 illustrates outputting a warning message to a driver by checking a battery state of charge (SOC) according to an embodiment of the present disclosure.

FIG. 6 shows a control process of converting to off mode during driving or in a shifting state which is not P range, according to an embodiment of the present disclosure.

It may be understood that the appended drawings are not necessarily to scale, presenting a somewhat simplified representation of various features illustrating the basic principles of the present disclosure. The specific design features of the present disclosure as included herein, including, for example, specific dimensions, orientations, locations, and shapes should be determined in part by the particularly intended application and use environment.

In the figures, the same reference numerals refer to the same or equivalent parts of the present disclosure throughout the several figures of the drawing.

### DETAILED DESCRIPTION

Because various modifications may be applied to the present disclosure and there may be various embodiments, specific embodiments are illustrated in the drawings and described in the present disclosure. However, is the specific embodiments are not intended to limit the present disclosure to specific embodiments and should be understood to include all changes, equivalents, or substitutes included in the spirit and technical scope of the present disclosure.

Suffixes “module” and “part” used herein are only used for the name distinction between components and should not be interpreted as having a premise of physicochemical classification or separation.

Terms including ordinal numbers such as “first” and “second” may be used to explain various components, but the components are not limited by the terms. The terms may be used only in a name for distinguishing one component from another component, and the sequence between them is recognized by the context of the description, not by the names.

The term “and/or” is used to include all the cases of any combination of the plural items that are subject to the target. For example, “A and/or B” means all three cases of “A”, “B”, “A and B”.

When a component is referred to as “connected” or “linked” to another component, the component may be directly connected to or linked to that another component, but it should also be understood that there may be further another component therebetween.

The terms used in the present disclosure are used to explain a particular embodiment and are not intended to limit the present disclosure. A singular term in the present disclosure includes a plural term unless it is contextually and clearly means a singular form. In the present disclosure, the terms, such as “include” or “have”, are intended to specify that there are features, numbers, steps, operations, components or parts described in the present disclosure, or combinations thereof. It should be understood that the presence or the possibility of addition of numbers, steps, operations, components, part, or combinations thereof are not excluded in advance.

Unless defined differently, all the terms used here, including technical or scientific terms, have the same meaning as commonly understood by those who have normal knowledge in the technical field to which the present disclosure belongs. Terms such as what are commonly used in the dictionary should be interpreted as having the meaning of the context of the relevant technology and are not interpreted as an ideal or excessively formal meaning unless defined clearly in the present disclosure.

In addition, “unit”, “control unit”, “control device” or “controller” is a term widely used as a name of a device that controls its function and does not mean a general function unit. For example, a device, which uses one of the above names, may include a communication device, which communicates with another controller or sensor for control of the function, a recording medium, which may be read by a computer that stores an operating system, a logic command, and input and output information, etc., and one or more processors, which perform judgment, operations, and decisions required for the function control.

Further, a processor may include a semiconductor integrated circuit and/or electronic devices that perform at least one or more of comparison, judgment, operation, and decision to achieve a programmed function. For example, the processor may be any one or a combination of a computer, a microprocessor, CPU, ASIC, and an electronic circuits (circuitry, logic circuits).

In addition, a recording medium readable by a computer (or briefly called a memory) includes all kinds of storage devices that may be read by a computer system. For example, the storage medium may include at least one of a flash memory, a hard disk type memory, a micro type memory, a card type memory, a secure digital (SD) card, an extreme digital (XD) card, a random access memory (RAM), a static RAM, a read-only memory (ROM), a programmable ROM (PROM), an electrically erasable PROM (EEPROM), a magnetic RAM (MRAM), a magnetic disk type memory, or an optical disk type memory.

Such a recording medium may be electrically connected to a processor, and the processor may load and record data from the recording medium. A recording medium and a processor may be integrated or physically separated.

Hereinafter, embodiments of the present disclosure are described in detail with reference to the accompanying drawings.

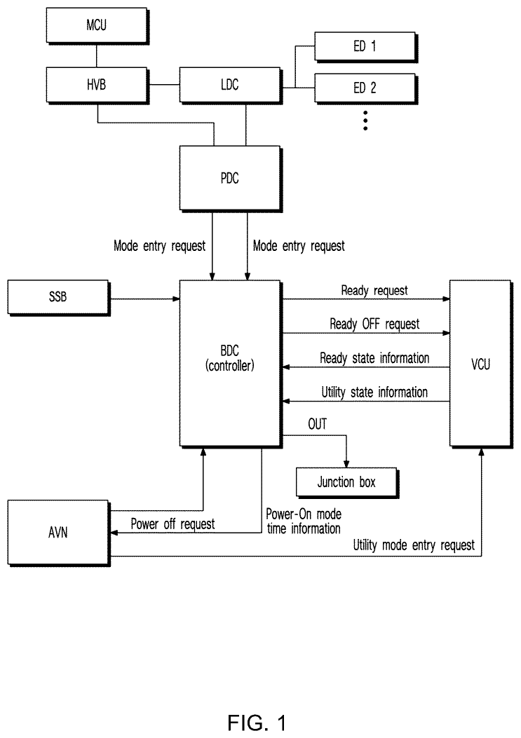

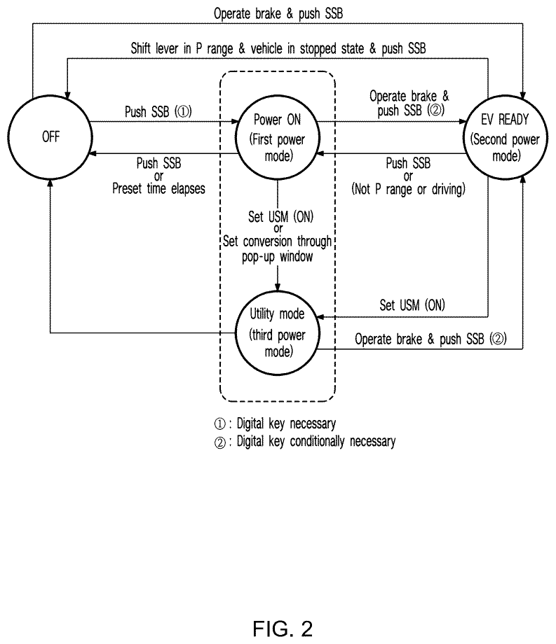

FIG. 1 is a conceptual diagram showing the main configuration of an electric vehicle according to an embodiment of the present disclosure, and FIG. 2 shows a converted state of power modes according to an embodiment of the present disclosure.

The electric vehicle according to the present embodiment includes a start button (SSB), a high voltage battery (HVB), driving essential devices that receive power from the high voltage battery (HVB), convenience devices that receive power from the high voltage battery (HVB), and a controller that converts power mode into one of off mode, first power mode, and second power mode.

In addition, the electric vehicle includes a DC/DC converter (LDC) that converts the power of the high voltage battery (HVB) to low voltage power before being supplied to electronic devices including driving essential devices and convenience devices.

The high voltage battery (HVB) may include a plurality of battery cells that outputs a unit voltage between 2.7 V and 4.2 V. The high voltage battery (HVB) may further include a predetermined number of battery cells may be connected in series or in parallel to thereby form one module. The high voltage battery HVB may have a form in which one or more battery modules are packaged as one battery packaged as the battery modules are connected in series or in parallel to output, for example, about 400 V, about 800 V, or several kV.

The high voltage battery (HVB) may include a battery management system BMS, and the BMS may include a battery management unit (BMU), a cell monitoring unit (CMU), and a junction box (BJB).

The BMS performs a cell balancing function to guarantee the performance of the entire battery pack by constantly maintaining the voltage of each cell, a state of charge (SOC) function, which calculates the capacity of the entire battery system, and battery cooling, charging, and discharge control, etc.

The BMU receives the information of all cells from the CMU and performs the function of BMS based on the information.

The BMU may comprise two micro control units (MCU), and each MCU has one CAN communication port. A CAN interface may be included to communicate with a vehicle controller, which may correspond to a higher level device of the BMS, and a CAN interface, which may collect information of the CMU which may correspond to a lower level device of the BMS, may also be included.

The CMU may be directly attached to the battery cell to sense voltage, current, temperature, etc. The CMU does not perform operations related to the BMS algorithm and may only play a sensing role. A plurality of battery cells may be connected to one CMU, and the information of each cell is delivered to the BMU through the CAN interface.

BJB is a pack-level detection mechanism of BMS and a connection medium between a high voltage battery (HVB) and a drivetrain. The battery voltage and the current flowing inside and outside the battery are measured and recorded to accurately calculate the SOC. In addition, BJB may perform important functions for safety such as overcurrent detection and insulation monitoring.

Driving essential devices are essential for vehicle driving, which may vary depending on the vehicle type. In an embodiment, the driving essential device may include a power domain controller (PDC), a motor control unit (MCU), a motor driven power steering (MDPS), an integrated electric brake (IEB), a vehicle control unit (VCU), an electric power control unit (EPCU), an electric oil pump (EOP), a headlamp, a turn signal, a brake light, a wiper, a dashboard (cluster), a door unlock, and/or a body domain controller (BDC), etc.

Here, the PDC controls a high voltage battery (HVB) and/or a DC/DC converter (LDC) according to the command entered for power supply to various electronic devices.

The MCU controls the drive motor according to the input command.

MDPS refers to a power steering system in which a motor is connected to the steering axis connected to front wheels of a vehicle so that the steering wheel of the vehicle may be turned by small force.

IEB means an integrated electric brake.

In addition, the VCU performs drive motor control, regenerative braking control, air conditioning load control, electronics load power supply control, cluster display, distance to empty (DTE), reservation/remote charging/air conditioning, and/or analog/digital signal processing and diagnosis, etc.

The EPCU is a device that controls the overall movement of the vehicle along with the control of the drive motor in an electric vehicle. The EPCU has similar functions to those of electronic control unit (ECU) and transmission control unit (TCU) of the existing internal combustion engine vehicle.

The EOP is a device in charge of cooling and lubrication of a reducer.

The BDC refers to a platform controller that provides electronic functions to the body domain area. The BDC performs at least one of a body control function, a digital key access/start function, a tire air pressure monitoring function, an immobilizer function, or a digital key authentication and autonomous parking control function.

The digital key may be a FOB key and may also be registered on a smartphone or NFC card and used as a phone key or card key.

In this embodiment, the BDC functions as a controller that switches the power mode, but the embodiment is not necessarily limited thereto.

The BDC outputs a command to a junction block according to the power mode decision, and the junction block operates the relay according to the command to enable power supply for the corresponding power mode.

Meanwhile, convenience devices are not essential for driving and include electronic devices related to driver convenience, and a representative example thereof is audio video navigation (AVN).

Additionally, the start button (SSB) includes a mechanical or electronic button (e.g., touch sensitive) provided inside the vehicle.

Referring to FIG. 2, in this embodiment, the power mode includes an off mode, a first power mode, a second power mode, and a third power mode.

In this embodiment, the first power mode is named “power-on” mode, the second power mode is named “EV READY” or “READY” mode, and the third power mode is named utility mode, but the present embodiment is not limited to the names of the power modes.

Power-on mode is a mode in which power is applied to convenience devices, and EV READY mode is a mode in which power is applied to all electronic devices in the vehicle, including driving essential devices and convenience devices.

When the BDC decides to switch to EV READY mode, the BDC may transmit an EV READY request to the VCU, and the VCU accordingly switches the state to a control mode where the vehicle can start at any time.

Meanwhile, even in the power-on mode, power may be applied to all electronic devices in the electric circuit, but because the EV READY request is not transmitted to the VCU, the vehicle is not ready to start immediately.

The utility mode is a mode in which power is applied to convenience devices. The utility mode differs from the power-on mode in that it may be selected through a user setting menu provided by a user interface, which are described below, and that there is no off mode transition according to the setting time, which are described below.

Hereinafter, switching between each mode is described in detail with reference to FIG. 2.

First, when the start button (SSB) is pressed once in the off mode, i.e., when it is operated once, the power mode is converted to the power-on mode.

Also, when the brake is operated in the off mode or power-on mode, and the start button (SSB) is operated at the same time, the power mode is switched to EV READY mode.

When the start button (SSB) is operated in the off mode or the first set time has elapsed, the power mode is switched to the off mode. In other words, if the start button (SSB) is operated before the first set time has elapsed, the mode is switched to the off mode, and if the first set time has elapsed without the operation of the start button (SSB), the mode is automatically switched to the off mode.

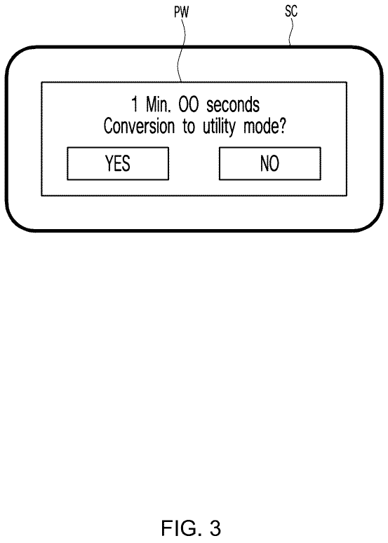

Referring to FIG. 3, at this time, a pop-up window (PW) requesting the user to select whether to switch to the utility mode before the elapse of the first set time may be displayed through the AVN screen (SC) that provides the user interface.

When the user selects conversion to utility mode through a pop-up window (PW), the power mode is switched accordingly. At this time, if the first set time elapses without the user's selection, the power mode is switched to the off mode as described above.

In EV READY mode, when the shift lever is placed in the parking position, i.e., P range, and the start button (SSB) is operated while the vehicle is less than a set speed (e.g., 5 kph) or stopped, the power mode switches to the off mode.

In EV READY mode, if the shift lever is not in P range or the start button (SSB) is operated while the vehicle is running, the power mode switches to power-on mode.

The user may select utility mode through the user settings menu provided through the AVN screen, and the power mode is switched from power-on mode or EV READY mode to utility mode accordingly.

Additionally, in addition to such user selection, if the state of charge (SOC) of the high voltage battery (HVB) is greater than or equal to the first set SOC, the power mode may be automatically switched to utility mode.

In utility mode, unlike power-on mode, there is no time restriction like the first set time.

However, a situation where the SOC of the high voltage battery (HVB) is insufficient may occur due to long-term use, and as a countermeasure, when the SOC of the high voltage battery (HVB) reaches the second set SOC, a warning message may be output on the AVN screen.

When the brake and start button (SSB) are operated in utility mode, the power mode switches to EV READY mode.

Also, in utility mode, the power mode is switched to the off mode when the start button (SSB) is operated without operating the brake or by selection through the user settings menu.

Switching from off mode to power-on mode and EV READY mode is conditional on the digital key being recognized as being present inside the vehicle.

In addition, in the case of switching from the power-on mode to the EV READY mode or from the utility mode to the EV READY mode, the digital key is not required as long as it is within the second set time, but after the second set time has elapsed, it is conditional on the digital key being present inside the vehicle.

Here, when switching from utility mode to EV READY mode, the second set time is counted from the start of power-on mode when switching from power-on mode to utility mode, and when switching from EV READY mode to utility mode, it is counted from the start of utility mode.

In the case of switching from the power-on mode to the EV READY mode, the second set time is counted from the start of the power-on mode.

Meanwhile, in EV READY mode, in the case that the start button (SSB) is operated while the shift lever is not in P range, and conversion to off mode is requested or the vehicle door is opened, in the case that the start button (SSB) is operated while the shift lever is not in P range in the power-on mode, and switching to EV READY mode is requested, or in the case that when the brake and start button (SSB) is operated when the shift lever is not in P range, and conversion to EV READY mode is requested, a warning message may be output through the AVN screen.

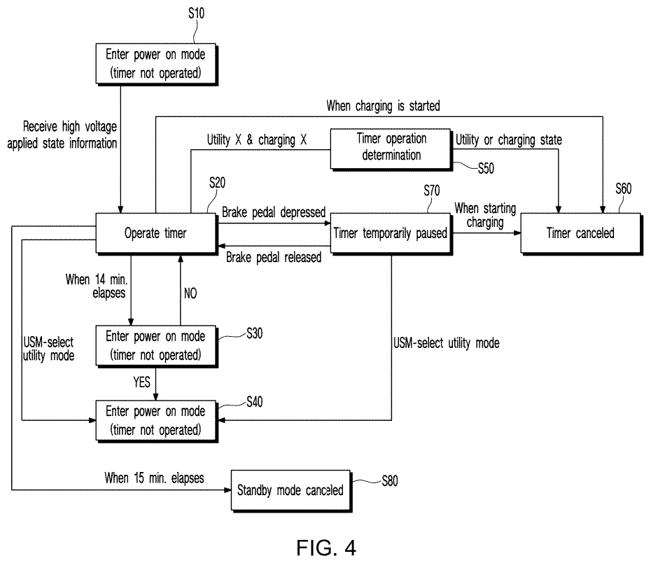

FIG. 4 shows a standby state control process in power-on mode, which is described in detail below.

First, when entering the power-on mode (S10), timer operation starts in step S20.

When the timer reaches 14 minutes, which is 1 minute before the first set time (e.g., 15 minutes), a pop-up window (PW) inquiring about switching to utility mode is output through the AVN screen in step S30.

If the user selects the switch to utility mode in the pop-up window (PW) (YES in S30), utility mode is entered in step S40.

If the user selects not to switch to utility mode in the pop-up window (PW) (NO in S30), it returns to step S20 and continues running the timer.

As an example of the first set time in step S20, when 15 minutes have elapsed, the standby mode is canceled in step S80, and as described above, because the first set time has elapsed, the mode is switched to off mode.

When charging of the electric vehicle begins in step S20, the timer operation is canceled in step S60.

Additionally, if the utility mode is selected through the AVN user settings menu in step S20, the utility mode is entered (S40).

The timer operation in step S20 is canceled in step S60 through a decision on whether to enter utility mode or charge the electric vehicle (S50).

Meanwhile, if the brake is operated in step S20, i.e., before 15 minutes have elapsed after starting the power-on mode, the timer is paused in step S70. At this time, when the brake is released, it returns to step S20 and continues running the timer.

If the utility mode is selected through the AVN user settings menu in step S70, the utility mode is entered (S40). Further, when charging of the electric vehicle begins in step S70, the timer operation is canceled in step S60.

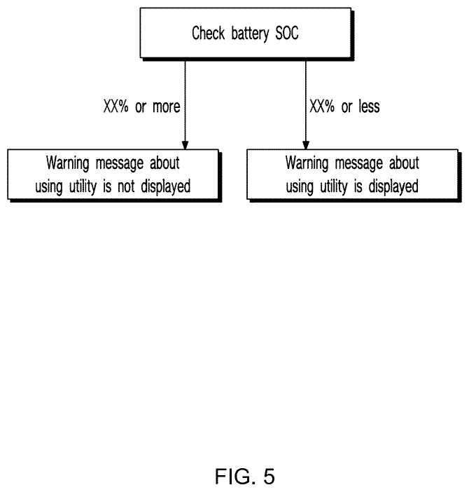

Meanwhile, referring to FIG. 5, if the SOC of the high voltage battery (HVB) is below the set value, a warning message about use of utility mode may be output on the AVN screen. This may be performed after step S30. In other words, a warning message as shown in FIG. 5 may be output before entering the utility mode after step S30.

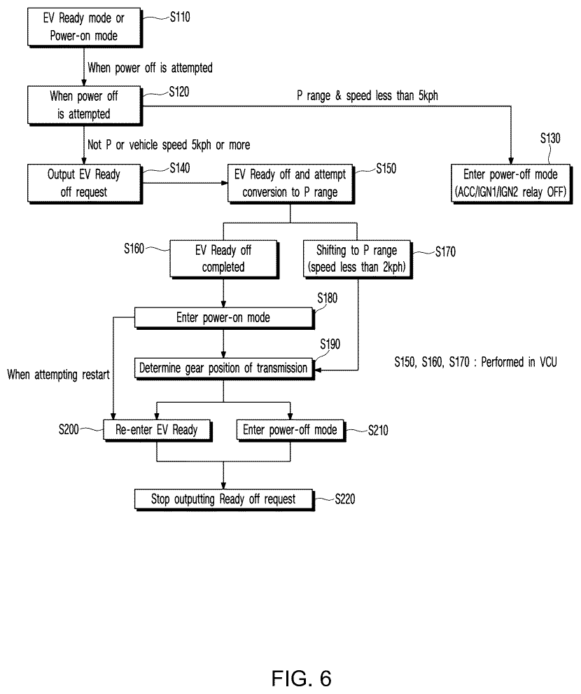

FIG. 6 shows the control process of switching to the off mode while driving or in a shifting state other than P range.

First, if the user attempts to switch to the off mode in EV READY mode or power-on mode (S110), the gear stage of the shift lever and vehicle speed information are determined in step S120.

Also, as a result of the determination, if the shift lever is in the P range and the vehicle speed is less than the set speed (e.g., 5 kph), the off mode is entered in step S130.

If the off mode is determined, the command for the relay switch is output to the junction block. The junction block controls the relay according to the command and switches to the power supply state in the off mode.

Meanwhile, as a result of determination in step S120, if the shift lever is not in P range or the vehicle speed is greater than or equal to the set speed (e.g., 5 kph), the EV READY mode is determined in step S140, and an EV READY mode off request is transmitted to the VCU. The VCU turns off the EV READY mode in step S150 and attempts to switch to the P range of the transmission gear.

Additionally, when the EV READY mode is completely turned off in step S160, the VCU transmits the information on the state to the BDC, and the BDC enters the power-on mode in step S180 and determines the position of the transmission gear in step S190.

At this time, if a restart attempt is made in step S180, i.e., when the driver steps on the brake and operates the start button (SSB), the EV READY mode is re-entered in step S200.

Meanwhile, when the conversion of the transmission gear to P range gear is completed in step S170, the VCU notifies the information on the conversion to the BDC.

When the BDC enters the power-on mode in step S180 or receives notification of a change to P range gear from the VCU, the BDC determines the position of the transmission gear in step S190.

In step S190, if the transmission gear is in P range, the off mode is entered in step S210, and if the transmission gear is not in P range, the EV READY mode is re-entered in step S200.

And, after steps S200 and S210, the output of the EV READY mode off request sent to the VCU in step S220 is stopped.

What is claimed is:

1. A method of controlling power of an electric vehicle, the electric vehicle including a start button, a high voltage battery, at least one driving essential device configured to receive power from the high voltage battery, at least one convenience device configured to receive power from the high voltage battery, and a controller configured to convert a power mode to one of an off mode, a first power mode, or a second power mode, the method comprising:
converting, by the controller, the power mode to the first power mode in response to a determination that the start button is operated one time in the off mode;
converting the power mode to the second power mode in response to a determination that the start button is operated and a brake is operated in the off mode or the first power mode; and
converting the power mode to the off mode in response to a determination that a first set time elapses in the first power mode,
wherein the first power mode is a mode in which the power is applied to the at least one convenience device, and
wherein the second power mode is a mode in which the power is applied to the at least one driving essential device.

2. The method of claim 1, further comprising:
converting, by the controller, the power mode to the off mode in response to a determination that the start button is operated before the first set time elapses in the first power mode.

3. The method of claim 1, further comprising:
converting, by the controller, the power mode from the second power mode to the first power mode in response to a determination that the start button is operated in a state that a shift lever is not in P range or during driving.

4. The method of claim 1, further comprising:
converting, by the controller, the power mode to a third power mode in response to a determination that the third power mode is selected through a user settings menu of a user interface in the first power mode or the second power mode,
wherein the third power mode is a mode in which the power is applied to the at least one convenience device.

5. The method of claim 4, further comprising:
outputting, by the controller, a pop-up window requesting a user selection for conversion to the third power mode through the user interface before the first set time elapses.

6. The method of claim 4, further comprising:
automatically converting the power mode to the third power mode in response to a determination that a state of charge (SOC) of the high voltage battery is equal to or greater than a first set SOC.

7. The method of claim 4, further comprising:
outputting, by the controller, a warning message through the user interface in response to a determination that the SOC of the high voltage battery reaches a second set SOC in the third power mode.

8. The method of claim 4, further comprising:
converting, by the controller, the power mode to the second power mode in response to a determination that the brake and the start button are operated in the third power mode.

9. The method of claim 8,
wherein converting the third power mode to the second power mode is performed in response to recognition of a digital key within the electric vehicle when a second set time has elapsed, and
wherein converting is performed without the recognition of the digital key within the electric vehicle when the second set time has not yet elapsed.

10. The method of claim 9,
wherein the second set time is counted from a start of the first power mode in response to a determination that the first power mode is converted to the third power mode, and
wherein the second set time is counted from a start of the third power mode in response to a determination that the second power mode is converted to the third power mode.

11. The method of claim 1, further comprising:
converting, by the controller, the power mode to the first power mode and converting a shift lever to P range; and
converting the first power mode to the off mode, in response to a determination that the start button is operated during driving in the second power mode.

12. The method of claim 1, wherein converting the power mode to the second power mode comprises:
converting the power mode to the second power mode in response to recognition of a digital key within the electric vehicle when a second set time has elapsed since a start of the first power mode; and
converting the power mode to the second power mode without the recognition of a digital key within the electric vehicle when the second set time has not yet elapsed.

13. The method of claim 1, further comprising:
outputting, by the controller, a warning message, in at least one of a first case where conversion to the off mode is requested according to operation of the start button or a vehicle door is opened in a state where a shift lever is not in P range in the second power mode, a second case where conversion to the second power mode is requested by operation of the start button in a state where the shift lever is not in P range in the first power mode, or a third case where conversion to the second power mode is requested by operation of the brake and the start button in a state where the shift lever is not in P range.

14. An electric vehicle comprising:
a start button;
a high voltage battery;
at least one driving essential device configured to receive power from the high voltage battery;
at least one convenience device configured to receive power from the high voltage battery; and
a controller configured to convert a power mode to one of an off mode, a first power mode, or a second power mode,
wherein the first power mode is a mode in which the power is applied to the at least one convenience device,
wherein the second power mode is a mode in which the power is applied to the at least one driving essential device, and
wherein the controller is further configured to
convert the power mode to the first power mode in response to a determination that the start button is operated one time in the off mode,
convert the power mode to the second power mode in response to a determination that the start button is operated and a brake is operated in the off mode or the first power mode, and
convert the power mode to the off mode in response to a determination that a first set time elapses in the first power mode.

15. The electric vehicle of claim 14,
wherein the controller is further configured to convert the power mode to the off mode in response to a determination that the start button is operated before the first set time elapses in the first power mode.

16. The electric vehicle of claim 14,
wherein the controller is further configured to convert the power mode to the first power mode from the second power mode in response to a determination that the start button is operated in a state that a shift lever is not in P range or during driving.

17. The electric vehicle of claim 14,
wherein the controller is further configured to convert the power mode to a third power mode in response to a determination that the third power mode is selected through a user settings menu of a user interface in the first power mode or the second power mode, and
wherein the third power mode is a mode in which the power is applied to the at least one convenience device.

18. The electric vehicle of claim 17,
wherein the controller is further configured to output a pop-up window requesting a user selection for conversion to the third power mode through the user interface before the first set time elapses.

19. The electric vehicle of claim 17,
wherein the controller is further configured to automatically convert the power mode to the third power mode in response to a determination that a state of charge (SOC) of the high voltage battery is equal to or greater than a first set SOC.

20. The electric vehicle of claim 17,
wherein the controller is further configured to output a warning message through the user interface in response to a determination that the SOC of the high voltage battery reaches a second set SOC in the third power mode.
